(19) United States
(12) Patent Application Publication
(10) Pub. No.: US 2007/0275592 A1
(43) Pub. Date: Nov. 29, 2007

(54) Battery adapter

(76) Inventor: Curtis Andrew Thompson, Plano, TX (US)

Correspondence Address: Curtis Thompson, 3929 Picato Dr., Plano, TX, 75074, US

(21) Appl. No.: 11/439,607

(22) Filed: May 24, 2006

(51) Int. Cl. H01R 3/00

(52) U.S. Cl. 439/500

(57) ABSTRACT

A battery adapter allowing a physically smaller battery or batteries to be used interchangeably in an application where a physically larger battery would normally be used. The adapter can be formed economically and be used with standard of rechargeable batteries.

### BACKGROUND OF THE INVENTION

Field of the Invention

This invention relates to battery adapters and more specifically to adapters designed to allow physically smaller batteries to be used in applications normally requiring a physically larger battery.

Description of Prior Art

Many different battery adapters are known in the prior art. Prior art reviewed includes U.S. Pat. No. 3,969,148; U.S. Pat. No. 3,990,919; U.S. Pat. No. 4,020,245; U.S. Pat. No. 4,037,026; U.S. Pat. No. 4,057,677; U.S. Pat. No. 4,124,026; U.S. Pat. No. 4,397,920; U.S. Pat. No. 4,724,189; U.S. Pat. No. 4,767,358; U.S. Pat. No. 5,240,787; U.S. Pat. No. 6,531,244. In many cases, the prior art adapters have multiple parts, which are difficult to use, have restraining devices for the smaller battery, which are ineffective or use a battery too small to power the intended electronic device. The present invention utilizes a commonly known spring contact configuration not previously seen in prior art making installation of batteries into the adapter quick and easy. The present invention also prevents improperly installed batteries in the adapter from damaging electrical units and restrains the battery inside the adapter to prevent interruptions in power during movement of an electronic device. The adapter is also intended to use batteries, which are physically smaller by one standard size than the battery they replace or utilize multiple batteries to maximize power supplied to the electronic device.

### SUMMARY OF THE INVENTION

The three embodiments of the present invention detail unique adapters not previously realized, intended to allow standard and rechargeable physically smaller batteries to be used in applications normally requiring physically larger batteries. The object of the present invention is to provide an adapter constructed in one piece, which allows batteries to be inserted into the adapter quickly and easily. Another object of this invention is to prevent batteries inserted upside down from damaging electronic devices by recessing the positive contact making a physical separation between the negative contact of a battery and the positive contact of the adapter. Yet another object of the present invention is to restrain the battery after insertion into the adapter by means of the recessed positive contact preventing lateral movement of the battery and pressure from the negative contact spring which forces the positive contact of the battery into the adapter positive contact recess. Still another object of the present invention is the use of batteries one physical size smaller than the battery size intended for the electronic device or the use of multiple batteries in the adapter to maximize the power supplied to the electronic device.

### BRIEF DESCRIPTION OF THE DRAWINGS

The benefits of this invention are better understood from a study of the preferred embodiment drawings wherein:

FIG. 1A is a perspective view of the first embodiment of the present invention, showing the void where a smaller battery can be inserted.

FIG. 1B is a cross-sectional view of the first embodiment of the present invention, showing a battery positioned inside the adapter.

FIG. 2A is a side view of the second embodiment of the present invention, showing one of two retaining clips to maintain the position of the smaller battery inside the adapter.

FIG. 2B is a section view of the second embodiment of the present invention, showing the smaller battery positioned in the adapter.

FIG. 3A is a perspective view of the third embodiment of the present invention, showing one of the three void configurations.

FIG. 3B is a section view of the third embodiment of the present invention, showing one of the three void configurations.

FIG. 3C is a cross-sectional view of the third embodiment of the present invention, showing the three battery compartments and the negative contact conical spring arrangement.

FIG. 3D is a side view of the third embodiment of the present invention positive contact configuration.

FIG. 3E is a top view of the third embodiment of the present invention positive contact configuration.

FIG. 3F is a side view of the third embodiment of the present invention negative contact configuration.

FIG. 3G is a top view of the third embodiment of the present invention negative contact configuration.

### DESCRIPTION OF PREFERRED EMBODIMENT

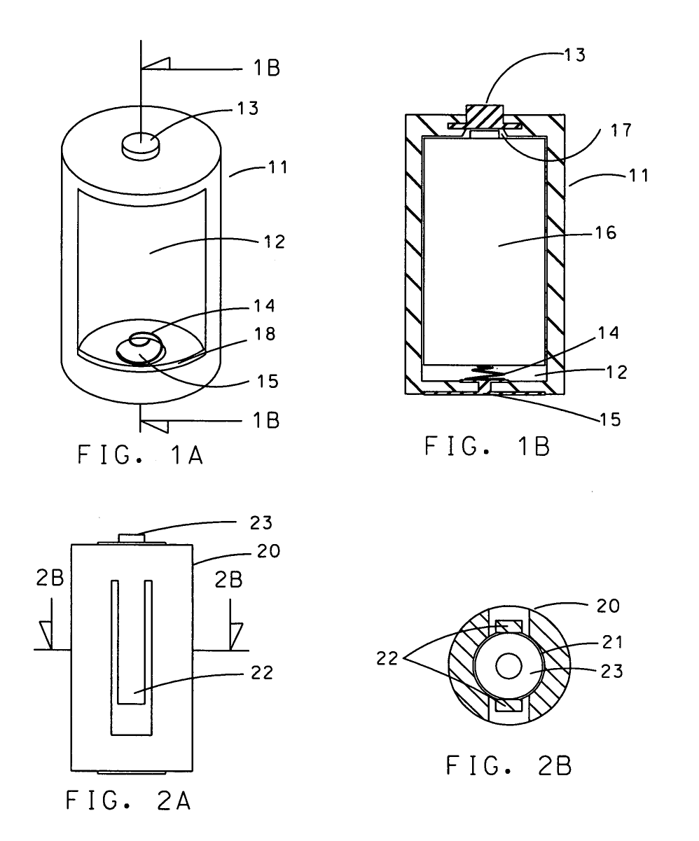

Referring to FIGS. 1A and 1B, the first embodiment of the current battery adapter invention, consists of the body 11 of the adapter, which is dimensionally equivalent to a standard battery size. The void 12 inside the body 11 of the adapter is large enough to allow a smaller battery 16 to be removably disposed therein. Positive contact 13 positioned at the top of body 11 is constructed of an electronically conductive material positioned to make contact with the positive terminal of smaller battery 16. The recess 17 at the top of void 12 helps maintain the relative position of battery 16 inside void 12 while preventing contact with the negative terminal of battery 16 during inverted insertion of battery 16. Conical spring 14 is centrally located in the bottom of void 12, positioned to make contact with the negative terminal of battery 16. Conical spring 14 is constructed of an electrically conductive material which is permanently and conductively connected to negative contact 15, which is constructed of an electrically conductive material, is located at the bottom of body 11. Lip 18 on the lower portion of body 11 maintains the relative position of battery 16 within void 12 in combination with pressure from compressed conical spring 14 and lateral stability provided by recess 17.

Referring to FIGS. 2A and 2B, the second embodiment of the current battery adapter invention, consists of the body 20 of the adapter, which is dimensionally equivalent to a standard battery size. The void 21 inside the body 20 of the adapter is large enough to allow a smaller battery 23 to be removably disposed therein. Retainer clips 22 can be an integral part of the body 20 or can be formed separately and attached to the body 20. Retainer clips 22 apply pressure to the sides of batteries 23 to maintain the position of battery 23 inside body 20 of the adapter.

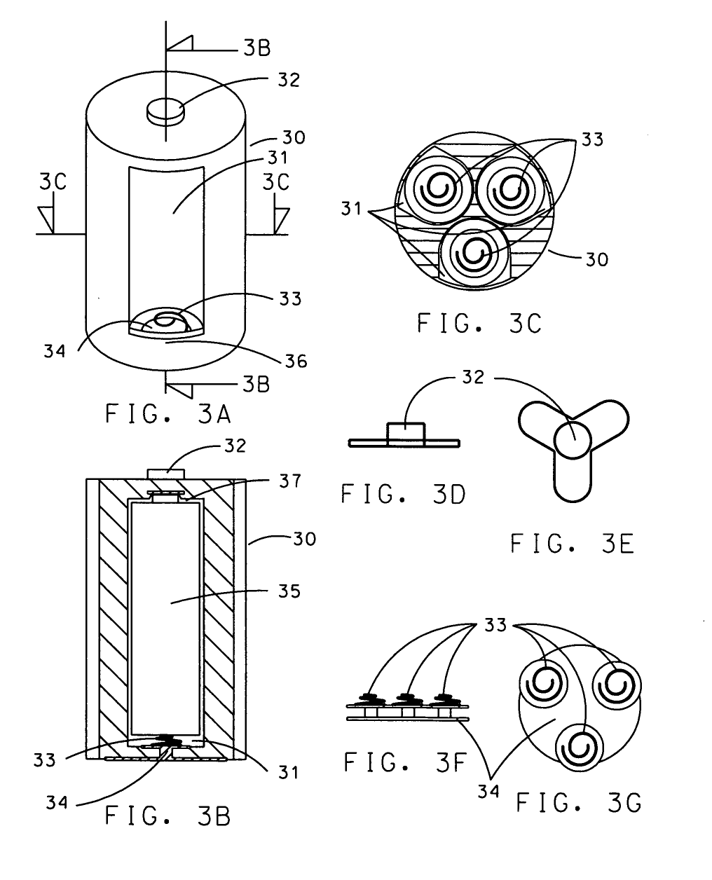

Referring to FIGS. 3A and 3B, the third embodiment of the current battery adapter invention, consists of the body 30 of the adapter, which is dimensionally equivalent to a standard battery size. Three voids 31 inside body 30 are large enough to allow three smaller batteries 35 to be removably disposed therein. Positive contact 32 shown from the side in FIG. 3F and from the top in FIG. 3H located at the top of body 30 is constructed of an electronically conductive material and positioned to make contact with the positive terminals of three smaller batteries 35. Three recess 37 at the top of void 31 help maintain the relative position of three batteries 35 inside voids 31 while preventing contact with the negative terminals of batteries 35 during inverted insertion of batteries 35. Three conical springs 33 are centrally located in the bottom of voids 31, positioned to make contact with the negative terminals of three batteries 35. Three conical springs 33, constructed of an electrically conductive material, are permanently and conductively connected to the negative contact 34. Negative contact 34, constructed of an electronically conductive material, is located at the bottom of body 30. Lips 36, on the lower portion of body 30 across the bottom of voids 31, maintains the relative position of batteries 35 within voids 31 in combination with pressure from compressed conical springs 33 and lateral stability provided by recess 37.

With respect to the above description, it is to be realized the optimal dimensional relationships for the parts of the invention, to include variations in size, materials, shape, form and assembly are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A battery adapter for allowing a physically smaller battery to replace a physically larger battery, said device comprising:
a container member having the physical dimensions of a larger battery;
a void in said container allowing said smaller battery to be centrally disposed therein;
a means for restraining said smaller battery inside the said void of said container;
a positive contact at one end of said container, said contact extending from beyond said end of said container to a centrally positioned recess in said void of said end of said container;
a negative contact at second end of said container, said contact extending from the exterior of said end of said container into said void of said container.

2. An adapter as described in claim 1, wherein said negative contact is a conductive conical spring.

3. An adapter as described in claim 1, wherein said negative contact is a conductive bar spring.

4. An adapter as described in claim 1, wherein said container is made in one piece of molded plastic.

5. An adapter as described in claim 1, wherein said means for restraining said smaller battery is a lip across said opening at said negative end of said container.

6. An adapter as described in claim 1, wherein said container member is a nonconductive material molded in one piece.

7. An adapter as described in claim 5, wherein said lip is transversely curved.

8. An adapter for allowing a smaller battery to replace a larger size battery, said device comprising:
a container member having the physical dimensions of a larger battery;
an opening in said container extending the length of said container sized to accommodate said smaller battery centrally disposed therein;
a means for restraining said smaller battery inside said container.

9. An adapter as described in claim 8, wherein said means for restraining said smaller battery is two integral molded clips.

10. An adapter as described in claim 8, wherein said means for restraining said smaller battery are metallic clips attached to said container member.

11. An adapter as described in claim 8, wherein said container member is plastic molded in one piece.

12. An adapter as described in claim 8, wherein said container member is a nonconductive material molded in one piece.

13. An adapter for allowing one to three physically smaller batteries to replace a physically larger battery, said device comprising:
a container member having the physical dimensions of a larger battery;
three voids in said container allowing said smaller batteries to be centrally disposed into said voids of said container;
a means for restraining said smaller batteries inside said void of said container;
three positive contacts at one end of said container, said contacts extending from three recesses in said void of said container to a common contact extending above said end of said container;
three negative contacts at second end of said container, said contacts extending from said void of said container connecting to a common contact at said second end of said container.

14. An adapter as described in claim 13, wherein said negative contacts are conductive conical springs.

15. An adapter as described in claim 13, wherein said negative contacts are conductive bar springs.

16. An adapter as described in claim 13, wherein said container member is plastic molded in one piece.

17. An adapter as described on claim 13, wherein said container is a nonconductive material molded in one piece.

18. An adapter as described in claim 13, wherein said means for restraining said smaller batteries are transverse lips across said voids at said second end of said container.

19. An adapter as described in claim 18, wherein said lips are transversely curved.
